(19) United States
(12) Patent Application Publication
(10) Pub. No.: US 2025/0129248 A1
(43) Pub. Date: Apr. 24, 2025

(54) TOUGHENED POLYAMIDE

(71) Applicants: Dow Global Technologies LLC, Midland, MI (US); Dow Silicones Corporation, Midland, MI (US)

(72) Inventors: Tao Wang, Shanghai (CN); Hongyu Chen, Shanghai (CN); Xilun Weng, Shanghai (CN); Kainan Zhang, Shanghai (CN); Ming Ming, Shanghai (CN); Wenke Miao, Shanghai (CN); Wuye Ouyang, Shanghai (CN)

(21) Appl. No.: 18/687,916

(22) PCT Filed: Nov. 15, 2021
(86) PCT No.: PCT/CN2021/130728

§ 371 Date: Feb. 29, 2024

(51) Int. Cl. C08L 77/02; C08J 3/22; C08K 5/17

(52) U.S. Cl. CPC C08L 77/02; C08J 3/226; C08K 5/17; C08J 2377/02; C08J 2451/08; C08L 2205/03; C08L 2310/00

(57) ABSTRACT

A toughened polyamide composition including a blend of: (A) at least one polyamide; (B) at least one impact modifier; and (C) at least one organic amine; a process for producing the toughened polyamide composition; and articles made from the toughened polyamide compositions.

### FIELD

The present invention relates to toughened polyamide compositions; and more specifically, the present invention relates to toughened polyamide compositions comprising blends of a polyamide, an impact modifier, and an organic amine that provide toughened polyamide compositions with improved room temperature impact strength and flowability properties.

### BACKGROUND

Nylon is a generic designation for a family of synthetic thermoplastic polymers composed of polyamides. Polyamides (PA) are repeating units linked by amide links. Nylon is a well-known synthetic thermoplastic polymer based on aliphatic or semi-aromatic polyamides in which at least 85% by weight of the amide-linkages (—CO—NH—) are attached directly to two aliphatic groups.

The synthetically engineered nylon (or PA) is a plastic with excellent mechanical properties, solvent resistance, wear resistance, and the like; and nylon material can be melt-processed into various fibers, films, or shapes for forming articles/products and parts for use in various applications. For example, toughened nylon composites can be used in applications such as automotive applications, industrial machinery applications, consumer applications, and electronic applications. However, nylon has a low notched impact strength, and particularly, nylon exhibits a disadvantage of poor toughness in a low-temperature environment, which limits further applications of nylon in the industry. Therefore, the industry is constantly seeking ways to better (increase or improve) the impact strength performance of toughened nylon.

Typically, the impact strength performance (or impact resistance) of toughened nylon is increased by adding impact modifier agents or additives to the toughened nylon. Adding an impact modifier material to the toughened nylon is one method to improve the impact strength of toughened nylon at both room temperature and temperatures lower than room temperature, especially in the automotive field.

To improve the impact resistance of nylon, an impact modifier agent is typically added to the nylon to form a toughened nylon compositions and such toughened nylon compositions are widely used by many industries for various application areas such as automotive, industrial machinery, consumer products, and electronic products, and the like. The performance properties of the toughened Nylon compositions such as good impact strength and good flowability are properties highly desired by the above industries. A good balance of these properties is particularly desired for designing thin walls and light weight parts in the electronic and automotive applications areas. To make thin parts from toughened nylon compositions for use in the above applications, sufficient flowability of the toughened nylon is needed; and to enable weight reduction design, an efficient impact modifier added to the toughened nylon composition is required to improve the stiffness/toughness/flowability balance of the toughened nylon composition. By reducing the thickness and weight of parts made from toughened nylon, the cost of this system can also be reduced.

Heretofore, the impact modifier (IM) predominantly used in toughened nylon (which is polar) has been maleic anhydride grafted polyolefin elastomers (which is non-polar). Usually, a maleic anhydride (MAH) is grafted to the backbone of a polyolefin elastomer (POE) to boost the compatibility between the POE and nylon through the reaction between the anhydride group grafted on the POE and the amine end group in nylon as shown in the following general chemical reaction scheme, (Scheme (I)):

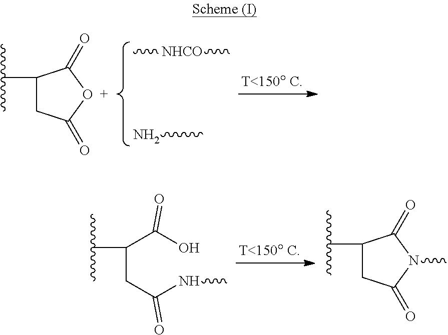

The maleic anhydride-grafted polyolefin (MAH-grafted POE) elastomer realizes the good compatibility property needed between the non-polar polyolefin and the high polar nylon. However, the above reaction causes an irreversible imide bond and significantly decreases the flowability property of the resulting nylon/POE blend composition.

Heretofore, numerous efforts have been conducted to improve the impact strength of toughened nylon including, for example, optimizing the MAH graft ratio of the IM, reducing the Tg of the POE, and/or providing crosslinking in the POE. Most of the efforts involve the design of the MAH-grafted POE (also abbreviated as “POE-g-MAH”) component, such as modifying the MAH level grafted onto the POE. However, the efforts by the aforementioned industries to optimize both the impact strength and flowability performance of toughened nylon compositions have been met with only limited success.

For example, CN110591100 mentions an ultra-low temperature resistant toughening agent (or impact modifier agent) used to increase the impact strength of nylon to form an ultra-low temperature resistant and impact resistant nylon (or “toughened nylon”). The impact modifier disclosed in the above reference is characterized as comprising a polyolefin elastomer which comprises a main chain of a polyolefin elastomer and a side chain of a polar monomer, wherein the side chain of the polar monomer is connected with an amino silicone oil. The nylon composition of the above reference requires a high loading of silicon oil (25% to 50% based on POE) which acts as plasticizer and the amino group is functionalized to act as a linker to facilitate compatibility between the nylon and the impact modifier. Also, there is no mention in the above reference that the impact modifier of the above reference improves the flowability of the toughened nylon composition. Moreover, the above reference does not specifically mention the use of a diamine or a triamine; it has been found that monoamines do not work to provide a toughened nylon; and data shows that tetramines also do not work.

U.S. Patent Application Publication No. 20060205880A1 mentions using an organic acid to provide a high flow POE (or ionomer toughened polyamide). The acid loading is up to 10% and toughener has a tensile modulus in the range of from 5 psi to 20,000 psi. The above reference discloses the use of an organic acid, which is well known to those skilled in the art, to cut PA molecular weight to improve the flowability of the PA. However, the above reference does not disclose the use of organic amines having a less than 4 functionality to improve the impact strength of a nylon composition.

CN11174796A mentions a nylon composite with improved hear resistance, including polyamide, mineral, glass fiber, hyperbranched polyamide and silane coupling agent. While the amino silane disclosed in the above reference provides an amino group to the nylon composite, the aminosilane is used for filler surface modification and no benefit on the flowability or impact strength properties of the nylon composite is disclosed, i.e., the amino silane of the above reference does not work to improve flowability and impact strength of the nylon composite.

WO2005054368A1 mentions using an organic acid to improve the flowability of a toughened polyamide (nylon) and combining an inorganic and organic stabilizer to maintain good heat and UV stability. The above reference describes a synergy of MAH grafted POE+organic acid+stabilizer to balance flowability and durability. However, WO2005054368A1 does not disclose improvements on impact strength. It disclosed the synergy of MAH grafted POE+organic acid+stabilizer to balance flowability and durability. However, there is no improvement on impact strength.

CN110580971A and CN110437612A mentions a cladding insulating material for outer layer of winding wire which is a nylon composite containing hindered amine as an antioxidant. However, the hindered amine has low reactivity which cannot not work as a surface reversible crosslinker; and thus, cannot improve the performance of flowability and impact strength of the nylon composite.

CN109722020 mentions a nylon composite and the use of an amino-functionalized polyolefin elastomer as a toughener. The above reference does not describe improving impact strength and/or flowability of the nylon composite.

An article entitled “Effect of glass fiber surface chemistry on the mechanical properties of glass fiber reinforced, rubber-toughened nylon 6” in Polymer, Volume 43, Issue 17, Pages 4673-4687 mentions different types of functionalized silanes, such as an amino silane; and the effect the amino silanes when used as surface treatment agents on glass fibers which are used in toughened Nylon 6. The amino silane is used in Nylon 6 as a crosslinker; however, the amino silane does not help to improve the flowability or impact strength of Nylon 6.

In view of the limitations on the impact strength and flowability properties of known toughened nylon compositions, it is desired to further improve the impact strength of toughened nylon, especially at low temperatures such as below −30° C., without deleteriously affecting other properties of the toughened nylon such as the flowability of the toughened nylon; and without significantly increasing the cost of manufacturing the toughened nylon.

It is also desired to provide a novel toughened nylon compound, material or composition having an increase in both the toughness property and flowability property; or at least find an advantageous balance of the two properties, by blending the proper components that form the improved toughened nylon composition such as (1) a polyamide (nylon compound, polymer, material or composition), (2) an efficient impact modifier, and (3) an organic amine.

### SUMMARY

In a broad embodiment, the present invention is directed to a toughened polyamide composition including a blend of: (A) at least one polyamide (e.g., a nylon compound); (B) at least one impact modifier; and (C) at least one particular organic amine such that the flowability and impact strength properties of the toughened polyamide composition are improved. In a preferred embodiment, the organic amine used in the toughened polyamide composition of the present invention has lower than 4 functionalities. In other embodiments, the organic amine is used as an additive in combination with a MAH grafted POE toughener; and such combination when added to a polyamide surprisingly forms a toughened polyamide composition with improved flowability and impact strength properties.

In another embodiment, the toughened polyamide composition of the present invention includes at least one polyamide, component (A), having a concentration of from 50 wt % to 98.99 wt %; at least one impact modifier composition, component (B), having a concentration of from 1 wt % to 50 wt %; and at least one organic amine, component (C), having a concentration of from 0.01 wt % to 10 wt %.

In still another embodiment, the present invention includes a process for preparing the above toughened polyamide composition exhibiting high flow and toughness.

In yet another embodiment, the process of preparing the above toughened polyamide composition of the present invention includes a melt-mixing step carried out in at least a two-screw extruder.

In even still another embodiment, the present invention includes an article manufactured using the above toughened polyamide composition.

In one or more embodiments, the above toughened polyamide composition and article production processes of the present invention includes an extrusion process and/or injection molding process.

Additional features and advantages of the embodiments of the present invention are set forth in the detailed description which follows, and in part will be readily apparent to those skilled in the art from that description or recognized by practicing the embodiments described herein, including the detailed description and the claims.

### DETAILED DESCRIPTION

Temperatures as used herein are in degrees Celsius (° C.).

“Room temperature (RT)” and/or “ambient temperature” herein means a temperature between 20° C. and 26° C., unless specified otherwise.

An “elastomer” is a polymer with viscoelasticity (i.e., both viscosity and elasticity) and with weak intermolecular forces, generally low Young's modulus and high failure strain compared with other materials. IUPAC (International Union of Pure and Applied Chemistry) defines the term “elastomer” as a “polymer that displays rubber-like elasticity.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, and the like. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

The term “composition” refers to a mixture of materials which comprise the composition, as well as reaction products and decomposition products formed from the materials of the composition.

A “nylon polymer composition” herein means a combination, mixture, or blend of at least one pure nylon polymer and at least one other different component, for example, elastomers, glass fibers, small molecular additives and the like.

An “impact modifier” herein is an additive added to a variety of plastic resins for increasing the flexibility, toughness, and impact strength of the plastics resins to meet physical property requirements of rigid parts made from such plastic resins.

The terms “impact toughness”, “impact strength”, and “impact resistance” herein, with reference to a nylon composition, mean the performance property of impact strength of the nylon composition evaluated by the Impact Method described in CHARPY, ISO 179. The above terms can be used interchangeably.

“Room temperature impact strength”, with reference to a nylon composition, herein means an impact strength value of the nylon composition tested under room temperature conditions.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like.).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “@” means “at”; μm=micron(s), g=gram(s); mg=milligram(s); mW/m−K=milliWatt(s) per meter-degree Kelvin; kJ/m²=kilojoule(s) per square meter; L=liter(s); mL=milliliter(s); g/mL=gram(s) per milliliter; g/L=gram(s) per liter; g/10 min=grams per 10 minutes; kg/m³=kilogram(s) per cubic meter; ppm=parts per million by weight; pbw=parts by weight; rpm=revolutions per minute; m=meter(s); mm=millimeter(s); cm=centimeter(s); μm=micrometer(s); min=minute(s); s=second(s); ms=millisecond(s); hr=hour(s); Pa=pascals; MPa=megapascals; Pa−s=Pascal second(s); mPa−s=millipascal second(s); g/mol=gram(s) per mole(s); g/eq=gram(s) per equivalent(s); mg KOH/g=milligrams of potassium hydroxide per gram(s); Mn=number average molecular weight; Mw=weight average molecular weight; pts=part(s) by weight; 1/s or sec⁻¹=reciprocal second(s) [s⁻¹]; ° C.=degree(s) Celsius; mmHg=millimeters of mercury; psig=pounds per square inch; kPa=kilopascal(s); %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

Specific embodiments of the present invention are described herein below. These embodiments are provided so that this disclosure is thorough and complete; and fully conveys the scope of the subject matter of the present invention to those skilled in the art.

In general, the present invention includes a toughened polyamide (e.g., nylon) formulation or composition useful for producing nylon articles/products or parts for various applications; and particularly in applications where the nylon composition requires having an increase in impact strength and flowability properties.

In a broad embodiment, the toughened polyamide composition includes a combination, mixture, or blend of: (A) at least one polyamide such as a nylon; (B) at least one impact modifier; and (C) at least one organic amine compound. To increase or enhance the flowability and impact strength properties of the toughened polyamide composition, the toughened polyamide composition is prepared by, for example, blending: (A) the at least one polyamide; (B) the at least one impact modifier; and (C) the at least one organic amine compound at predetermined concentrations and under predetermined conditions such as melt-blending temperatures using extrusion techniques.

For example, in one preferred embodiment, the toughened polyamide composition can include a blend of: from 50 wt % to 98.99 wt % of the at least one polyamide, component (A); from 1 wt % to 50 wt % of the at least one impact modifier composition, component (B); and from 0.01 wt % to 10 wt % of the at least one organic amine, component (C). The nylon composition of the present invention may further include (D) one or more other optional compounds, if desired.

In the present invention, it has been found that by blending a predetermined amount of a certain organic amine, an impact modifier product (e.g., a POE-g-MAH) and a toughened nylon, the impact strength of the toughened nylon composite can be significantly improved.

It is hypothesized that the presence of the certain organic amine in the above blended composition, the dynamic bond between the POE and the nylon increases. For example, when the certain organic amine combines with the impact modifier product such as POE-g-MAH, the MAH in the POE is replaced with an amide and/or an acid chemical; and because of this replacement the dynamic bond between the POE and the nylon is increased. In addition, the formed dynamic bond can significantly improve the flowability of toughened nylon compound while maintaining good compatibility between nylon and POE. By adding an organic amine to the nylon blended composition, it is theorized that the additive reacts with anhydride group in the POE-g-MAH to form an amide, acid, or salt chemical. Some embodiments of the general chemical reaction schemes of an additive reacting with MAH to form a dynamic bond with nylon are shown in the following general chemical reaction schemes, Schemes (II), (III) and (IV):

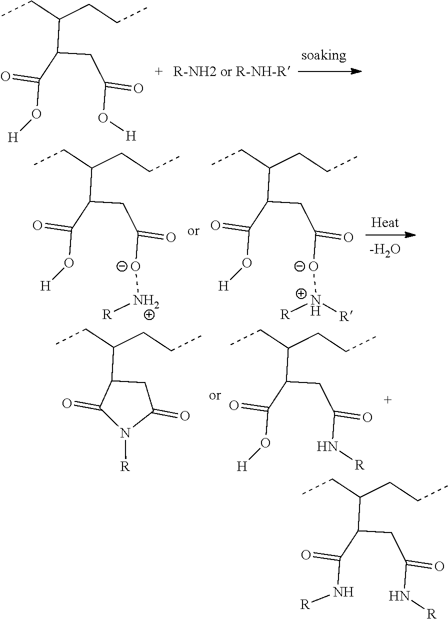

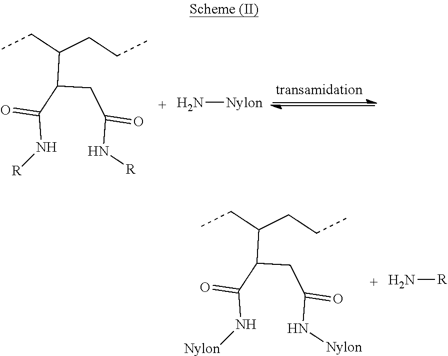

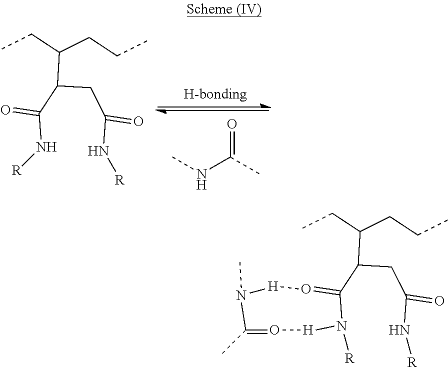

After any of the above reaction Schemes (II), (III) and (IV), the MAH group in the POE is consumed; and therefore, an irreversible crosslinking can be depressed between the MAH with the amine group in nylon. However, an amide, acid or salt can still form a dynamic bond or a hydrogen bond with the amine group in nylon during the compounding process or the injection molding process which are processes that are conducted at temperatures above 200° C. The bond formed between the amide, acid, or salt with the amine group in nylon provides good compatibility between the nylon and the POE while maintaining or improving the impact strength of the resultant toughened nylon.

The polyamide compound, component (A) of the nylon composition, is a polymer, which contains recurring amide groups (R—CO—NH—R′) as integral parts of the main polymer chain. The polyamide compound useful in the present invention can include one or more polyamide compounds. Suitable polyamide resins that may be used for the present invention include any known polyamides in the art. The polyamides useful in the present invention include, for example but are not limited to: aliphatic, semi-crystalline, aromatic or semi-aromatic nylon resins. The nylon resins are those prepared from starting materials of essentially a lactam or a diamine, and an aliphatic, semi-aromatic or aromatic dicarboxylic acid. Suitable lactams useful in the present invention include, for example, caprolactam and laurolactam. Suitable amines useful in the present invention include, for example, tetramethylenediamine, hexamethylenediamine (HMID), 2-methylpentamethylenediamine, undecamethylenediamine, dodecamethylenediamine, 2.2.4-(2,4,4-trimethylhexamethylenediamine, 5-methylnonamethylene diamine, metaxylylenediamine (XD), paraxylylenediamine and 2-methyl-1,5-pentamethylenediamine (MPMD). Suitable dicarboxylic acids useful in the present invention include, for example: adipic acid, suberic acid, azelaic acid, sebacic acid, dodecanedioic acid (DDDA), terephthalic acid (TPA), isophthalic acid (IPA), 2-chloroterephthalic acid, 2-methylterephthalic acid, 5-methylisophthalic acid, 5-sodium-sulfoisophthalic acid, hexahydroterephthalic acid and hexahydroisophthalic acid. In the present invention, nylon homopolymers or copolymers to be derived from the above starting materials are used either singly or as mixtures. Specific examples of polyamide resins that are desirable for compositions of the present invention include: (Nylon 6); polyundecanamide (Nylon 11); polylauramide (Nylon 12); polyhexamethylenadipamide (Nylon 66); polytetramethylenadipamide (Nylon 46); polyhexamethylenesebacamide (Nylon 610); polyhexamethylenedodecamide (Nylon 612); polyhexamethyleneterephthalamide (6T); polyhexamethylenisophthalamide (61); 2-methylpentamethylene terephthalamide (DT); 2-methylpentamethylene isophthalamide (DI); polyhexamethyleneterephthalamide/polycapramide copolymer (Nylon 6T/6); polyhexamethyleneterephthalamide/polydodecanamide copolymer (Nylon 6T/12); polyhexamethylenadipamide/polyhexamethyleneterephthalamide copolymer (Nylon 66/6T); polyhexamethylenadipamide/polyhexamethylenisophthalamide copolymer (Nylon 66/61), polyhexamethylenadipamide/polyhexamethylenisophthalamidef-polycapramide copolymer (Nylon 66/61/6); polyhexamethylenadipamide/polyhexamethyleneterephthalamide/-polyhexamethylenisophthalamide copolymer (Nylon 66/6T/61); polyhexamethyleneterephthalamide/polyhexamethylenisophthalamide copolymer (Nylon 6T/61); polyhexamethyleneterephthalamide/poly(2-methylpentamethylene)terephthalamide copolymer (Nylon 6T/M5T); polyhexamethyleneterephthalamidef-polyhexamethylenesebacamide/polycapramide copolymer (Nylon 6T/610/6); polyhexamethyleneterephthalamide/polydodecanamide/polyhexamethylenadipamide copolymer (Nylon 6T/12/66); polyhexamethyleneterephthalamide/polydodecanamide/-polyhexamethylenisophthalamide copolymer (Nylon 6T/12/61); poly m-xylylenadipamide (Nylon XD6); and mixtures and copolymers of any of the above compounds; and the like.

In some preferred embodiments, the polyamide component, component (A), may be any polyamide for which impact strength is desired. For example, the toughened polyamide composition component useful in the present invention can be, the at least one polyamide, component (A), selected from the group consisting essentially of: (Ai) Nylon-4,6; (Aii) Nylon-6,6; (Aiii) Nylon-6,10; (Aiv) Nylon-6,9; (Av) Nylon-6,12; (Avi) Nylon-11; (Avii) Nylon-12; (Aviii) 6T through 12T; (Aix) 6I through 12I; (Ax) at least one polyamide formed from 2-methylpentamethylene diamine and/or from hexamethylene diamine with one or more acids selected from the group consisting essentially of:(Axa) adipic acid, (Axb) isophthalic acid, (Axc) terephthalic acid, and (Axd) mixtures thereof; and (Axi) blends and/or copolymers of said nylons and polyamides thereof.

In other preferred embodiments, the polyamide can be selected from the group consisting Nylon 6 (a polycaprolactam which is made from caprolactam which self-polymerizes); Nylon 6,6 (a hexamethylene diamine—adipic acid condensation product which is a long chain synthetic polyamide having recurring amide groups in the polymer backbone); Nylon 4; Nylon 11; Nylon 6,10; or combinations thereof.

In still other preferred embodiments, the polyamide compound useful in the present invention is Nylon 6; Nylon 6,6; or mixtures thereof.

In some embodiments, the polyamide component, component (A), can be selected from commercially available compounds. For example, in some embodiments, some of the commercial polyamide compounds useful in the present invention can include Ultramid B3S Nylon 6 (available from BASF), Ultramid A3W Nylon 66 (available from BASF), and mixtures thereof.

The concentration of the polyamide component, component (A), can be from 50 wt % to 98.99 wt % in one embodiment, from 60 wt % to 92 wt % in another embodiment, from 70 wt % to 90 wt % in still another embodiment, based on the weight of the components in the toughened polyamide composition.

In a broad embodiment, the toughener component or impact modifier of the present invention, component (B), includes at least one toughener component and can include more than one toughener component. The impact modifier used in combination with the polyamide component (A) and the organic amine component (C) can be one or more impact modifier compounds having the following predetermined characteristics: MAH grafting ratio, density, and melt index, before being mixed with the other components of the toughened nylon composition.

For example, the impact modifier has a MAH graft level of from 0.1 percentage to 5 percentage in one embodiment; from 0.2 percentage to 2.0 percentage in another embodiment; and from 0.3 percentage to 1.0 percentage in still another embodiment.

For example, the impact modifier has a density of from 0.80 g/cc to 0.95 g/cc in one embodiment; from 0.83 g/cc to 0.93 g/cc in another embodiment; and from 0.85 g/cc to 0.92 g/cc in still another embodiment.

For example, the impact modifier has a melt index (MI; (@190° C. and 2.16 kg, in accordance with ASTM D1238) of from 0.1 g/10 min to 100 g/10 min in one embodiment; from 0.3 g/10 min to 50 g/10 min in another embodiment; and from 0.5 g/10 min to 20 g/10 min in still another embodiment.

In some embodiments, the toughener component, component (B), is selected from the group consisting essentially of, for example: (Bi) at least one polymer selected from the group consisting essentially of: (Bia) at least one polymerized ethylene; (Bib) at least one polymerized α-olefin having from 3 carbon atoms to 12 carbon atoms; (Bic) at least one polymerized unsaturated monomer having from 4 carbon atoms to 14 carbon atoms and selected from the group consisting essentially of: (Bic1) branched compounds; (Bic2) straight chain compounds; (Bic3) cyclic compounds; and (Bic4) mixtures thereof; and (Bid) mixtures thereof; (Bii) at least one unsaturated monomer selected from the group consisting essentially of: (Biia) at least one α,β ethylenically unsaturated dicarboxylic acid having from 3 carbon atoms to 8 carbon atoms; (Biib) at least one derivative of the at least one α,β ethylenically unsaturated dicarboxylic acid selected from the group consisting essentially of: (Biib1) at least one monoester of alcohols having from 1 carbon atom to 29 carbon atoms; (Biib2) at least one anhydride of the at least one derivative of the at least one α,β ethylenically unsaturated dicarboxylic acid; (Biib3) at least one metal salt of the at least one derivative of the at least one α,β ethylenically unsaturated dicarboxylic acid, (Biib4) at least one monoester of the at least one derivative of the at least one α,β ethylenically unsaturated dicarboxylic acid; wherein from 0 percent to 100 percent of the at least one derivative of the at least one α,β ethylenically unsaturated dicarboxylic acid has from 0 percent to 100 percent of carboxylic groups ionized by neutralization with metal ions; and (Biii) mixtures of components (Bi) and (Bii).

In some embodiments, the toughener component (impact modifier; component (B)), comprises a maleic anhydride functionalized elastomeric ethylene copolymer, a maleic anhydride functionalized ethylene, a olefin copolymer, a terpolymer of ethylene, acrylic ester and maleic anhydride, a maleic anhydride grafted (MAH) polyolefin elastomer (e.g., a POE-g-MAH); and combinations thereof. In one preferred embodiment, the toughener component, component (B), is a POE-g-MAH.

In some embodiments, the toughener component can be selected from commercially available compounds including, for example, Exxelor series products (available from ExxonMobil); and Tafmer series products (available from Mitsui Chemicals, Inc.), and mixtures thereof.

The concentration of the impact modifier compound, component (B), used in preparing the toughened nylon composition of the present invention includes, for example, from 1 wt % to 50 wt % based on the weight of components in the toughened nylon composition in one embodiment, from 8 wt % to 35 wt % in another embodiment, and from 10 wt % to 25 wt % in still another embodiment.

In a broad embodiment, the organic amine useful in the present invention, component (C), includes at least one organic amine component and can include more than one organic amine component. The organic amine, used in combination with the polyamide component (A) and the toughener component (B), can include one or more organic amine compounds having the following predetermined characteristics: a functionality of less than 4 and a Mw below 10,000 before being mixed with the other components of the toughened nylon composition.

For example, the organic amine can have a functionality of less than 4 in one general embodiment and less than 3 in another embodiment. In other embodiments, the organic amine can have a functionality of from 1 to less than 4 in one embodiment; from 1 to 3 in another embodiment; and from 1 to 2 in still another embodiment.

In general, the organic amine compound useful in the present invention can include one or more organic amine compounds known in the amines art. For example, suitable organic amines component (C), that may be used in the present invention may include, for example but are not limited to, the organic amines selected from the group consisting essentially of: (Ci) at least one primary amine group; (Cii) at least one secondary amine group; and (Ciii) mixtures of the at least one primary amine group, component (Ci), and the at least one secondary amine group, component (Cii), in one molecule with the proviso that the functionality of the molecule is below 4.

In some embodiments, the organic amine, component (C), can be selected from the group consisting essentially of: R—NH₂, R—NH—R′, NH₂—R—NH₂, R—NH—R′—NH₂, R—NH—R′—NH—R″, and mixtures thereof; wherein R, R′, R″ each separately is an alkyl group, an allyl group, or an alkoxyl group having a carbon number of from 2 to 30.

In some embodiments, the organic amine, component (C) used in the present invention may include one or more amines including, for example, hexyl amine, heptyl amine, octyl amine, nonyl amine, decyl amine, undecylamine, laurylamine, stearamine, benhenamine, aminoethylethanolamine (AEEA), ethylamino (ethyl)amine (EAEA), polyether amines (e.g., Jeffamine), and mixtures thereof.

In other embodiments, the organic amine, component (C), can be at least one polydimethyl siloxane (PDMS) with at least one primary amine group, at least one secondary amine group, or a mixture thereof. The at least one primary amine group, the at least one secondary amine group, or the mixtures of the organic amines, component (C) can be present at the end or side chain of the polydimethyl siloxane.

In still other embodiments, the organic amine component can be selected from commercially available compounds including, for example: Jeffamine (a polyether amine available from Huntsman Corporation), AEEA and EAEA (both available from The Dow Chemical Company); KF-8010 and X-22-161A (both available from SHIN-ETSU Chemical Company); and mixtures thereof.

The concentration of the organic amine compound, component (C), used in preparing the toughened nylon composition of the present invention includes, for example, from 0.01 wt % to 10 wt % based on the weight of components in the toughened nylon composition in one embodiment, from 0.02 wt % to 8 wt % in another embodiment, from 0.04 wt % to 6 wt % in still another embodiment, from 0.05 wt % to 4 wt % in yet another embodiment, and from 0.06 wt % to 3 wt % in even still another embodiment.

In some embodiments of the present invention, the various amines can either: (1) be used to soak POE-g-MAHs or (2) be compounded with POE-g-MAHs prior to adding the components to the toughened nylon composition. As a result of using the soaking or the compounding process, the capillary viscosity of the toughened nylon composition significantly decreases (which means flowability improves) using the soaking or the compounding process.

As an illustration of the present invention and not to be limited thereby, for example, by soaking 0.45 wt % (based on the weight of POE-g-MAH) of EAEA (2:1 mole ratio of amine and anhydride) in a POE-g-MAH with 0.50 wt % MAH grafted and a melt index of 1.6 g/10 min as measured at 190° C. with a 2.16 kg load, the toughened nylon indicates a 25% capillary viscosity reduction (e.g., from 356 Pa−s to 264 Pa−s at 770 s⁻¹) and a 70% room temperature impact strength increase (e.g., from 43.6 kJ/m² to 73.9 kJ/m²). Surprisingly, the impact strength of several other POE-g-MAH grades with different MAH grafted ratios, e.g., 0.90 wt % MAH and 0.35 wt % MAH; and with different melt index values of 1.3 g/10 min and 1.4 g/10 min, respectively, wherein the melt index values are measured at 190° C. with a 2.16 kg load, has been significantly improved as well.

In some embodiments, the toughened polyamide composition of the present invention can further include one or more optional components, additives or other agent compounds, if desired. The optional compounds, component (D), useful in the toughened polyamide composition of the present invention can include, for example, fillers, lubricants, plasticizers, pigments, dyes, antioxidants, stabilizers, nucleating agents, flame retardants, and blowing agents, and mixtures thereof.

In general, the concentration of the optional compounds when used in the toughened polyamide composition includes, for example, from 0 wt % to 50 wt % in one embodiment, from 0.01 wt % to 40 wt % in another embodiment, and from 0.1 wt % to 30 wt % in still another embodiment.

In one general embodiment, the toughened nylon composition can be produced by combining, blending or mixing: (A) at least one polyamide (e.g., a nylon compound); (B) at least one impact modifier component; (C) at least one organic amine; and (D) an optional additive, if desired. The resultant toughened polyamide composition comprising the mixture above exhibits at least a 10 percent decrease in capillary viscosity as compared to a conventional polyamide composition not containing any one or more components (A)-(C) in the mixture above; in particular, the at least one organic amine, component (C).

As an illustration of one embodiment of the present invention, but not to be limited thereby, the general process for producing the toughened nylon composition of the present invention includes admixing, combining or blending: (A) at least one polyamide at a concentration of from 50 wt % to 98.99 wt % based on the weight of the toughened nylon composition; (B) at least one toughener at a concentration of from 1 wt % to 50 wt % based on the weight of the toughened nylon composition; (C) at least one organic amine at a concentration of from 0.01 wt % to 10 wt %, based on the weight the toughened nylon composition; and (D) any optional components, if desired, at a concentration of less than 50 wt %, based on the weight the toughened nylon composition.

In some embodiments, the process of the present invention for preparing a toughened polyamide composition exhibiting improved toughness includes melt-mixing, in one step and at a predetermined temperature and for a predetermined period of time: the polyamide, component (A); the toughener, component (B); and the organic amine, component (C) described above. The one step melt-mixing step can be carried out at a melt temperature of greater than or equal to 200° C. in one embodiment, from 200° C. to 360° C. in another embodiment, and from 220° C. to 350° C. in another embodiment, from 230° C. to 340° C. in still another embodiment; and from 250° C. to 300° C. in yet another embodiment. The period of time for the one step melt-mixing step can be greater than 1 s in one embodiment, from 5 s to 10 min in another embodiment, from 20 s to 10 min in still another embodiment, and from 30 s to 5 min in still another embodiment. In one embodiment, the melt-mixing one step process above can be carried out in at least one extruder such as a conventional twin-screw (at least 2 screws) extruder.

In other embodiments, the process of the present invention for preparing a toughened polyamide composition exhibiting high flow and toughness can include at least the following two steps: a first step of (I) mixing, at a predetermined temperature and for a predetermined period of time, at least the following two components to form a blend composition component: (α) at least one impact modifier such as a maleic anhydride-grafted polyolefin elastomer (POE-g-MAH), component (B), described above; and (β) at least one organic amine compound such as the organic amine, component (C) described above; and a second step of (II) melt-mixing, at a predetermined temperature and for a predetermined period of time, at least the following two components to form a toughened polyamide composition: (γ) the at least one polyamide such as the polyamide (or nylon), component (A) described above; and (δ) the blend component (i.e., the composition mixture) from step (I).

The mixing first step (I) can be carried out, for example, by soaking components (B) and (C) together; and then mixing the components using, for example, at least one twin-screw extruder. The temperature of the first mixing step (I) can be below 90° C. in one embodiment, from 0° C. to 60° C. in another embodiment, and from 10° C. to 55° C. in still another embodiment. The period of time for the first mixing step (I) can be greater than 1 hr in one embodiment, from 1 hr to 48 hr in another embodiment, and from 2 hr to 24 hr in still another embodiment.

The temperature of the melt-mixing second step (II) can be greater than 200° C. in one embodiment, from 200° C. to 360° C. in another embodiment, from 220° C. to 350° C. in still another embodiment; from 230° C. to 340° C. in yet another embodiment; and from 250° C. to 300° C. in even still another embodiment. The period of time for the melt-mixing second step (II) can be greater than or equal to 1 s in one embodiment, from 5 s to 10 min in another embodiment, from 20 s to 10 min in still another embodiment, and from 30 s to 5 min in yet another embodiment. In one embodiment, the above melt-mixing second step (II) can be carried out in at least one extruder having at least two screws such as a conventional twin-screw extruder known in the art.

In other embodiments, the process for preparing a toughened polyamide composition exhibiting high flow and toughness can include at least the following three steps: a first step of (i) melt-mixing at least the following two components: (α) at least one impact modifier, e.g., the above-described impact modifier component (B) such as a POE-g-MAH; and (β) at least one organic amine component, e.g., the above-described organic amine component (C) to form a mixture of impact modifier and organic amine; a second step of (ii) pelletizing the impact modifier/organic amine mixture from step (i) to form a plurality of composite pellets, and a third step of (iii) melt-mixing at least the following two components to form a toughened polyamide composition: (γ) at least one polyamide; and (ε) the plurality of composite pellets from step (ii). In one embodiment, the melt-mixing third step (ii) above can be carried out in at least one extruder such as a conventional twin-screw extruder.

The temperature of the melt-mixing first step (i) can be above 100° C. in one embodiment, from 100° C. to 200° C. in another embodiment, and from 120° C. to 180° C. in still another embodiment. The period of time for the mixing first step (i) can be greater than 20 s hr in one embodiment, from 20 s hr to 10 mins in another embodiment, and from 30 s to 5 mins in still another embodiment.

The pelletizing step (B) is carried out using conventional equipment such as a strand cutter to cut the resin, which exits the extruder, into pellets of a predetermined size.

The temperature of the melt-mixing third step (iii) can be greater than 200° C. in one embodiment, from 200° C. to 360° C. in another embodiment, from 220° C. to 350° C. in still another embodiment; from 230° C. to 340° C. in yet another embodiment; and from 250° C. to 300° C. in even still another embodiment. The period of time for the melt-mixing third step (iii) can be greater than or equal to 5 s in one embodiment, from 5 s to 10 min in another embodiment, from 20 s to 10 min in still another embodiment, and from 30 s to 5 min in yet another embodiment.

The process embodiments of the present invention for preparing a toughened polyamide composition, and the steps thereof as described above, can be carried out by conventional equipment known to those skilled in the art. For example, the mixing of the components to form a uniform or homogeneous mixture can be carried out by known blenders or mixers such as twin-screw extruders, melt kneaders, batch mixers, and the like.

In general, a small (e.g., less than 500 nm) POE phase size in a toughened nylon is needed to affect the impact strength of the toughened nylon. Also, to increase the strength of the toughened nylon composition requires a strong interaction between the nylon (polar) and the elastomer (non-polar); and the strong interaction between the nylon (polar) and the elastomer (non-polar) achieves the desired small particle size POE phase in the nylon phase. Based on the total weight of the nylon toughening agent, the content of the nylon component, component (A); the content of the polar impact modifier, component (B); and the content of the organic amine component (C) should be within a predetermined range of concentrations.

As an illustration of one embodiment of the present invention, but not to be limited thereby, the general process for producing the nylon composition of the present invention described above includes the step of admixing, combining or blending in a twin screw extruder from 50 wt % to 98.99 wt % of the at least one polyamide, component (A); from 1 wt % to 50 wt % of the at least one impact modifier composition, component (B); and from 0.01 wt % to 10 wt % of the at least one organic amine, component (C). The toughened nylon composition of the present invention processed in an extruder may further include (D) one or more other optional compounds, if desired.

As aforementioned, the toughened polyamide composition of the present invention exhibits several advantageous benefit(s) including, for example: (1) an increase in RT impact strength; and (2) a decrease in the capillary viscosity of the toughened nylon composition (which means that the flowability property of the toughened nylon composition improves). For example, the combination of an organic amine and an impact modifier (e.g., POE-g-MAH) with a toughened nylon component advantageously functions to effectively further toughen the nylon composition, i.e., the room temperature impact strength of the toughened polyamide composition can be boosted or enhanced. The toughened polyamide composition exhibits an increased impact strength balanced with a good flowability property while other mechanical performances of the toughened nylon composition such as flexural modulus, tensile strength, elongation, heat distort temperature (HDT) are maintained at an optimized level when the polyamide is blended with the POE-g-MAH and the organic amine to form the toughened nylon composition.

For example, in one general embodiment the nylon composition of the present invention containing the certain organic amines and impact modifiers with the nylon components, advantageously exhibits at least a 10% increase in room temperature (RT) impact strength as compared to a nylon composition containing different conventional impact modifiers. In another embodiment, the toughened polyamide composition of the present invention exhibits at least a 15% increase in RT impact strength; and in still another embodiment, the toughened polyamide composition of the present invention exhibits at least a 20% increase in RT impact strength. In yet another embodiment, the toughened polyamide composition of the present invention including the certain organic amines and impact modifiers with the nylon components exhibits from 10% to 50% increase in RT impact strength as compared to a polyamide composition containing other conventional impact modifiers.

In addition, the toughened polyamide composition of the present invention exhibits a decrease in the capillary viscosity which in turn provides an improvement in the flowability property of the composition. For example, in one embodiment, the capillary viscosity of the toughened polyamide composition exhibits a decrease of from a 5% decrease to a 40% decrease as compared to a polyamide composition containing other conventional impact modifiers; a decrease of from 7% decrease to 35% decrease as compared to a polyamide composition containing other conventional impact modifiers in another embodiment, and from 8% decrease to 30% decrease as compared to a polyamide composition containing other conventional impact modifiers in still another embodiment.

Another advantage of the present invention nylon composition is that the nylon composition can be used to manufacture lightweight articles/products or parts with thinner walls and using less composition because of the above improved properties of RT impact strength of the composition.

An article/product or part manufactured from the toughened nylon composition of the present invention can include, for example, electronic appliances, automotive parts, gears, and toys, and the like.

Once components (A), (B) and (C) are thoroughly and uniformly mixed together in molten form, the resulting molten mixture can be used to form an article/product or a shaped part using conventional processes and equipment. For example, an injection molding, extrusion molding, or blow molding process can be used to form the article/product or the shaped part from the composition.

In one preferred embodiment, the article/product or the shaped part is produced and processed, for example, using an extrusion molding process and extrusion equipment such as a twin-screw extruder. In general, the process for producing the article of the present invention from the toughened polyamide composition of the present invention includes, for example, the steps of:
(X) providing a toughened polyamide composition by admixing: (A) at least one polyamide; (B) an impact modifier; and (C) an organic amine; and
(Y) processing the composition of step (X) into an article using an extrusion process to form the article.

To create thinner and consequently lighter parts, it is required that nylon compositions have high impact strength and that nylon compositions flow through thinner walls. Improvement of both flow properties and toughness is obtained using the nylon composition of the present invention. Such high performance properties allow for downgauging interior and exterior parts and articles that require outstanding impact properties.

The impact modifier additive, the toughened nylon composition and articles, product or parts produced from the toughened nylon composition described above can be used in a wide range of polymer compositions and constructions. Generally, the toughened nylon composition with the impact modifier additive of the present invention is used in applications where there is a need for parts with a high impact strength (i.e., an increased toughness and durability) over parts made from conventional copolymers. For example, but not to be limited thereby, the toughened nylon compositions can be used in the various applications and may be formed into molded articles useful in fields requiring impact resistance and strength. In one embodiment, for example the toughened nylon compositions can be used in automotive applications for manufacturing automotive rigid parts and components. The automotive products can be made by conventional polymer processing.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise stated all parts and percentages are by weight on a total weight basis.

### Raw Materials

Some of the raw materials (ingredients) used in the Examples are described in Table I. Three various grades of POE-g-MAHs used in the Examples are referred to as POE-g-MAH1 (0.50 wt % MAH graft level and having a melt index (MI) of 1.6 g/10 min), POE-g-MAH2 (0.90 wt % MAH graft level and having a MI of 1.3 g/10 min), and POE-g-MAH3 (0.35 wt % MAH graft level and having a MI of 1.4 g/10 min).

Some of the amines used in the Examples include ethylamino(ethyl)amine (EAEA), a diamine with a functionality of 2; aminoethylethanolamine (AEEA), a diamine with a functionality of 3; and triethylenetetramine (TETA), a tetramine with a functionality of 4.

TABLE I
Raw Materials

| Material | Brief Description | Suppliers |
|---|---|---|
| PA6 B3s | Polyamide nylon | BASF |
| Z-6020 | Amino silane, functionality = 2 | DOW |
| KF-8010 | Amino PDMS, functionality = 2 | SHIN-ETSU |

### Formulations

The toughened nylon composite formulations used in the Examples were made based on the formulations described in Table II for Series 1 experiments and in Table III for Series 2 experiments.

TABLE II
Nylon Composite Formulations - Series 1

| | | | | | | | | Amine Loading |
|---|---|---|---|---|---|---|---|---|
| | PA6 | POE-g- | | | | | | Based on Nylon |
| Example | B3s | MAH1 | EAEA | AEEA | KF-8010 | TETA | Z-6020 | Composite |
| No. | (g) | (g) | (g) | (g) | (g) | (g) | (g) | (wt %) |
| Comp. Ex. A | 1,500 | | | | | | | |
| Comp. Ex. B | 1,200 | 300.0 | | | | | | 0 |
| Comp. Ex. C | 1,200 | 298.9 | | | | 1.1 | | 0.07 |
| Comp. Ex. D | 1,200 | 298.3 | | | | 1.7 | | 0.11 |
| Comp. Ex. E | 1,200 | 298.3 | | | | | 1.7 | 0.11 |
| Inv. Ex. 1 | 1,200 | 299.0 | 1.0 | | | | | 0.07 |
| Inv. Ex. 2 | 1,200 | 298.6 | 1.4 | | | | | 0.09 |
| Inv. Ex. 3 | 1,200 | 298.9 | | 1.1 | | | | 0.07 |
| Inv. Ex. 4 | 1,200 | 298.4 | | 1.6 | | | | 0.11 |
| Inv. Ex. 5 | 1,200 | 297.6 | | 2.4 | | | | 0.16 |
| Inv. Ex. 6 | 1,200 | 293.4 | | | 6.6 | | | 0.44 |
| Inv. Ex. 7 | 1,200 | 286.8 | | | 13.2 | | | 0.88 |

TABLE III
Nylon Composite Formulations - Series 2

| | PA6 | POE-g- | POE-g- | POE-g- | | | Amine Loading |
|---|---|---|---|---|---|---|---|
| Example | B3s | MAH1 | MAH2 | MAH3 | EAEA | AEEA | Based on POE |
| No. | (g) | (g) | (g) | (g) | (g) | (g) | (wt %) |
| Comp. Ex. B | 1,200 | 300 | | | | 0 | 0 |
| Comp. Ex. F | 1,200 | | 300.0 | | | | 0 |
| Comp. Ex. G | 1,200 | | | 300 | | | 0 |
| Inv. Ex. 8 | 1,200 | 298 | | | | 2.0 | 0.13 |
| Inv. Ex. 9 | 1,200 | | 298.1 | | | 1.9 | 0.13 |
| Inv. Ex. 10 | 1,200 | | 298.6 | | 1.40 | | 0.09 |
| Inv. Ex. 11 | 1,200 | | | 298.95 | 1.05 | | 0.07 |

The general procedure used for preparing the toughened nylon composite formulations samples described in Tables II and III and the methods used for testing the samples are described in the testing procedures described herein below.

Soaking Process to Blend Amines with POE

The amines used in the Examples were blended with POE using POE pellets and a soaking process. The soaking process includes first mixing the amines with the POE pellets at room temperature and then allowing the small molecular weight amines to penetrate the POE pellets. For example, the soaking process was carried out as follows: 400 g of POE pellets were first placed in a 2 L plastic container; and then the amines are added to the container according to a weight percentage of the amines present in the container to form the formulations described in Tables II and III. The container was shaken for 5 min in different directions (e.g., the container was shaken in an up-and-down direction and a left-to-right direction at similar frequencies). After shaking the container, the container was laid down for 5 min. After laying the container down for 5 min, the container was picked up and the steps of shaking and laying down the container for 5 min was repeated. The combination of shaking and laying down the container steps was repeated 6 times. After the 6 repetitions, the container was kept at room temperature for another 3 hours.

Compounding of Soaked POE into Nylon

A number of nylon samples were first dried in dehumidifier for at least 4 hr at 120° C. A twin-screw extruder (a ZSK18 twin-screw extruder available from Coperion Company) was used for compounding the soaked POEs into the dried nylon samples. The following extruder parameters were used: power=19.2 KW, D=18 mm, L/D=48. The conditions/parameters of the extruder for compounding the Amine/POE pellets and nylon samples were as follows: the barrel temperature of the extruder was set as follow zone 1=150° C., zone 2=195° C., zone 3=260° C., zone 4=260° C., zone 5=260° C., zone 6=260° C., and zone 7=250° C. in the range of from RT to −350° C.; the screw speed of the extruder was 300 rpm; and the feeding rate of blend material to the extruder was 10 kg/hr. After the compounding step, the resultant compounds were cut into pellets having a diameter of from 0.5 mm to 1 mm and a length of from 2 mm to 5 mm.

### Testing Methods

The following testing methods and measurement procedures were used to test the specimens prepared according to the above General Procedure for Preparing the Toughened Nylon Composition Specimens for Testing.

### Capillary Viscosity Test

The compounded nylon/POE samples were first dried in a dehumidifier for at least 4 hr at 120° C.; and after drying the compounded samples, the compounded samples were sealed in an aluminum bag under vacuum. The moisture content in the compounded nylon/POE samples was tested by the so-called Karl-Fischer method using an 874 Oven Sample Processor (available from Thermo-Fisher Co. Ltd.). The moisture of the compounded nylon/POE samples is recommended to be below 1,000 ppm before the samples are tested using the capillary viscosity test. The capillary rheometer instrument used for the capillary viscosity test was a Gottfert rheograph 26 (available from Gottfert Inc.). The test temperature used for the capillary viscosity test was 260° C. The capillary length used was 30 mm; and the capillary diameter was 1 mm. Shear rate used in the test was in the range of from 90 1/s to 7,000 1/s. The data described in the Tables related to viscosity is reported at a shear rate of @770 1/s.

### Injection Molding Process

The compounded nylon/POE pellets were first dried in dehumidifier for at least 4 hr at 120° C. before the samples were subjected to injection molding. The injection molding machine, Fanuc Roboshot S-2000i100BH (available from Fanuc), was used for the injection molding process. The compounded samples were subjected to injection molding to produce specimens and to conduct impact testing on the specimens using the impact strength test described herein below. The parameters for the injection molding machine and process were as follows: the barrel temperature for the injection screw was set between 250° C. and 260° C., the cooling temperature was 190° C., the cooling time was 15 s, the injection rate was 30 mm/s, and the injection pressure was 200 MPa.

### Impact Strength Test

The impact strength testing method used for testing the impact performance of specimens prepared in the Examples is described in CHARPY, ISO 179 (“ISO” stands for “International Organization for Standardization”). CHARPY, ISO 179 specifies a method for determining the Charpy impact strength of plastics under defined conditions. Each of the specimens used in the test is a flat test specimen made from the formulations of Tables II and III; and having the following dimensions: 80 mm in length×10 mm in width×4 mm in thickness. CHARPY, ISO 179 defines the method used to determine the resistance of plastic to breaking when impacted in a three-point bend configuration, using a pendulum system with an appropriately sized hammer arm. The test is un-instrumented and is used to determine the energy required to break a specimen. Different test parameters are specified according to the type of material that the specimen is made of, as well as the type of notch cut in the specimen.

In the Examples described herein, the following general procedure was followed: all specimens were notched with a 2 mm radius notch. Before the specimens were tested, all specimens were first dried at 120° C. for 4 hr in a dehumidifier. And then, the specimens were equilibrated at room temperature in the dehumidifier for 2 days.

Each of the specimens to be tested was mounted horizontally on a pendulum impact testing machine and supported unclamped at both ends. The hammer of the testing machine was released and allowed to strike through the specimen. If breakage did not occur with the first hammer arm used, a heavier hammer was used sequentially until failure occurred. Then upon breakage, the resulting energy and break types were recorded.

The impact test conditions used were as follows: a pendulum capacity of 4 Joules and a specimen conditioning at ≥6 hr at room temperature or ≥6 hr at −40° C. in a freezer. The specimen in the freezer was removed from the freezer and impacted within 5 s. The test conditions were at room temperature (i.e., a temperature of 23° C.±2° C.) and a 50% RH±10% RH.

### Test Results

The viscosity results of the toughened nylon formulations described in Table II and Table III were obtained by conducting the above-described Capillary Viscosity Test; and the viscosity results for the formulations in Table II for the Series 1 experiments are described in Table IV; and the viscosity results for the formulations in Table II for the Series 2 experiments are described in Table V.

TABLE IV
Viscosity of Nylon Composite Formulations - Series 1

| | Amine Loading | Capillary Viscosity |
|---|---|---|
| Formulation | Based on Nylon Composite | @ 770 s⁻¹ |
| Example No. | (wt %) | (Pa-s) |
| Comp. Ex. A | 0 | 252 |
| Comp. Ex. B | 0 | 356 |
| Comp. Ex. C | 0.07 | 304 |
| Comp. Ex. D | 0.11 | 324 |
| Comp. Ex. E | 0.11 | 347 |
| Inv. Ex. 1 | 0.07 | 270 |
| Inv. Ex. 2 | 0.09 | 264 |
| Inv. Ex. 3 | 0.07 | 324 |
| Inv. Ex. 4 | 0.11 | 291 |
| Inv. Ex. 5 | 0.16 | 248 |
| Inv. Ex. 6 | 0.44 | 277 |
| Inv. Ex. 7 | 0.88 | 251 |

TABLE V
Viscosity of Nylon Composite Formulations - Series 2

| | Amine Loading | Capillary Viscosity |
|---|---|---|
| Formulation | Based on Nylon Composite | @ 770 s⁻¹ |
| Example No. | (wt %) | (Pa-s) |
| Comp. Ex. B | 0 | 356 |
| Comp. Ex. F | 0 | 340 |
| Comp. Ex. G | 0 | 288 |
| Inv. Ex. 8 | 0.13 | 204 |
| Inv. Ex. 9 | 0.13 | 251 |
| Inv. Ex. 10 | 0.09 | 185 |
| Inv. Ex. 11 | 0.07 | 178 |

Injection molded test specimens were fabricated from the toughened nylon formulations described in Tables II and III; and the impact strength of some of the injection molded test specimens made from some of the toughened nylon formulations described in Tables II and III were obtained by conducting the above-described Impact Strength Test on the injection molding specimens prepared according to the injection molding method described above. The impact strength results for the specimens made from the formulations in Table II for the Series 1 experiments are described in Table VI; and the impact strength results for the specimens made from the formulations in Table III for the Series 2 experiments are described in Table VII.

TABLE VI
Impact Strength of Nylon Composite Formulations - Series 1

| | | Amine Loading | Izod Impact | Flexural |
|---|---|---|---|---|
| | Formulation | Based on Nylon Composite | RT | Modulus |
| Example No. | Example No. | (wt %) | (kJ/m²) | (MPa) |
| Comp. Ex. I | Comp. Ex. A | 0 | 6.2 | NT⁽¹⁾ |
| Comp. Ex. J | Comp. Ex. B | 0 | 43.6 | 1,727 |
| Comp. Ex. K | Comp. Ex. C | 0.07 | 13.9 | NT |
| Comp. Ex. L | Comp. Ex. D | 0.11 | 7.8 | NT |
| Comp. Ex. M | Comp. Ex. E | 0.11 | 30.9 | NT |
| Inv. Ex. 12 | Inv. Ex. 1 | 0.07 | 74.0 | NT |
| Inv. Ex. 13 | Inv. Ex. 2 | 0.09 | 73.9 | 1,675 |
| Inv. Ex. 14 | Inv. Ex. 3 | 0.07 | 78.6 | 1,652 |
| Inv. Ex. 15 | Inv. Ex. 4 | 0.11 | 81.0 | 1,610 |
| Inv. Ex. 16 | Inv. Ex. 5 | 0.16 | 73.6 | 1,448 |
| Inv. Ex. 17 | Inv. Ex. 6 | 0.44 | 76.9 | NT |
| Inv. Ex. 18 | Inv. Ex. 7 | 0.88 | 78.8 | 1,642 |

Note for Table VI:
⁽¹⁾NT means the sample was not tested.

TABLE VII
Impact Strength of Nylon Composite Formulations - Series 2

| | | Amine Loading | Izod Impact | Flexural |
|---|---|---|---|---|
| | Formulation | Based on Nylon Composite | RT | Modulus |
| Example No. | Example No. | (wt %) | (kJ/m²) | (MPa) |
| Comp. Ex. N | Comp. Ex. B | 0 | 43.6 | 1,727 |
| Comp. Ex. O | Comp. Ex. F | 0 | 36.9 | 1,603 |
| Comp. Ex. P | Comp. Ex. G | 0 | 76.1 | 1,673 |
| Inv. Ex. 19 | Inv. Ex. 8 | 0.13 | 71.3 | NT⁽¹⁾ |
| Inv. Ex. 20 | Inv. Ex. 9 | 0.13 | 56.2 | NT |
| Inv. Ex. 21 | Inv. Ex. 10 | 0.09 | 61.4 | 1,749 |
| Inv. Ex. 22 | Inv. Ex. 11 | 0.07 | 71.4 | 1,726 |

Note for Table VII:
⁽¹⁾NT means the sample was not tested.

### Discussion of Results

### Series 1 Test Results

In Series 1 described in Table IV, different types and loading of organic amines were soaked into a MAH grafted POE (POE-g-MAH1) in Series 1. Then, the soaked POE was compounded with B33s (a mid-viscosity Nylon 6 available from BASF). The capillary viscosity and the impact strength are described in Tables IV and VI, respectively. The capillary viscosity was tested at different shear rates from a low shear rate to a high shear rate. However, Table IV shows the capillary viscosity of the samples tested at a sheer rate of 770 s⁻¹. This shear rate was selected to simplify the data obtained from testing since capillary viscosity results at different shear rates showed a similar trend. As described in Table VI, the toughened nylon sample with POE-g-MAH1 (Comp. Ex. J) indicates a higher impact strength compared to the untoughened nylon sample (Comp. Ex. A, no amine is used in Comp. Ex. A); but the viscosity for Comp. Ex. B increased significantly with the POE-g-MAH1 as part of the composition. It is common to observe a viscosity increase due to the crosslinking between the grafted MAH and the amine group at the nylon chain end. By soaking organic amines into the POE-g-MAH1, the samples containing POE-g-MAH1 soaked with amines (e.g., Inv. Ex. 1 to Inv. Ex. 7, Comp. Ex. C and Comp. Ex. D) indicated a lower viscosity than the comparative sample (Comp. Ex. B). Using the same organic amine, the viscosity of the Examples decreased when the organic amine loading increased. For example, Inv. Ex 2 has a lower viscosity than Inv. Ex 1; and Inv. Ex 5 has a lower viscosity than Inv. Ex 3 and Inv. Ex. 4. This surprising phenomenon is a clear indication that organic amines help to decrease the viscosity of toughened nylon, and in turn, improve the flowability of the toughened nylon compositions.

Moreover, the impact strength at room temperature of the test specimens made from the toughened nylon composition samples of the Inv. Ex. 12 to Inv. Ex. 18 has been significantly improved compared to the nylon composition samples of Comp. Ex. J, particularly when the functionality of the organic amine used in the Examples is less than 3. When the functionality of an amine used in the Examples is above 3, such as triethylenetetramine (TETA) which is a tetra amine, over-crosslinking of POE occurs and such over-crosslinking significantly reduces the impact strength of toughened nylon. For example, Comp. Ex. L indicated significant lower RT impact strength than Comp. Ex. J. Therefore, it is beneficial to control the functionality of the amine to less than or equal to 3. In Comp. Ex. M, amino silane was tested but resulted in the nylon having low impact strength which is undesirable. It is believed that the poor impact strength for the sample of Comp. Ex. M can be attributed to the over-crosslinking of POE since the amine, Z-6020, is a tri-methoxyl silane which provides high crosslinking density.

### Series 2 Test Results

In Series 2 described in Tables V and VII, various POE samples with different graft levels of MAH were used as impact modifiers (for example, POE-g-MAH1 had 0.50% graft level, POE-g-MAH2 had 0.90% graft level, and POE-g-MAH3 had 0.35% graft level). The impact modifiers were added to a Nylon 6 matrix (BASF B3s) and examined. As shown in Table V, the viscosity of toughened Nylon 6 with an amine soaked into the Nylon 6 is significantly lower than the viscosity of the comparative nylon composition without an amine. For example, the nylon sample of Inv. Ex. 8 compared to the nylon sample of Comp. Ex. B; the nylon samples of Inv. Ex. 9 and Inv. Ex. 10 compared to the nylon sample of Comp. Ex. F; and the nylon sample of Inv. Ex. 11 compared to the nylon samples of Comp. Ex. G. The above results indicate that the organic amines of the present invention work surprisingly advantageously on capillary viscosity in different types of POEs.

The above results from Table VII, also show that: (1) the impact strength at room temperature value of the amine-soaked polyamide samples is much better than the non-soaked polyamide samples, for example, as evidenced by Inv. Ex. 19 to Inv. Ex. 22 compared to Comp. Ex. N; and (2) the flexural modulus performance of the amine-soaked polyamide samples is essentially maintained at a level comparable to the non-amine-soaked polyamide samples, for example as evidenced by Inv. Ex.13, 14, 15, 16, 21 and 22.

Based on above results, it can be concluded that organic amine-soaked POE can significantly improve the flowability and room temperature impact strength of a toughened nylon (or polyamide).

### Other Embodiments

Embodiment 1: The toughened polyamide composition of the present invention, wherein the at least one polyamide, component (A), is selected from the group consisting essentially of: (Ai) Nylon-4,6; (Aii) Nylon-6,6; (Aiii) Nylon-6,10; (Aiv) Nylon-6,9; (Av) Nylon-6,12; (Avi) Nylon-11; (Avii) Nylon-12; (Aviii) 6T through 12T; (Aix) 61 through 12I; (Ax) at least one polyamide formed from 2-methylpentamethylene diamine and/or from hexamethylene diamine with one or more acids; and (Axi) blends or copolymers of said nylons and polyamides thereof.

Embodiment 2: The composition of the present invention, wherein the at least one polyamide of component (Ax) is selected from the group consisting essentially of: (Axa) adipic acid, (Axb) isophthalic acid, (Axc) terephthalic acid, and (Axd) mixtures thereof.

Embodiment 3: The composition of the present invention, wherein the at least one impact modifier, component (B), is selected from the group consisting essentially of: (Bi) at least one polymer selected from the group consisting essentially of: (Bia) at least one polymerized ethylene; (Bib) at least one polymerized α-olefin having from 3 carbon atoms to 12 carbon atoms; (Bic) at least one polymerized unsaturated monomer having from 4 carbon atoms to 14 carbon atoms; and (Bid) mixtures thereof; (Bii) at least one unsaturated monomer selected from the group consisting essentially of: (Biia) at least one α,β ethylenically unsaturated dicarboxylic acid having from 3 carbon atoms to 8 carbon atoms; and (Biib) at least one derivative of the at least one α,β ethylenically unsaturated dicarboxylic acid; and (Biii) mixtures of components (Bi) and (Bii).

Embodiment 4: The composition of the present invention, wherein the at least one polymerized unsaturated monomer having from 4 carbon atoms to 14 carbon atoms, component (Bic), is selected from the group consisting essentially of: (Bic1) branched compounds; (Bic2) straight chain compounds; (Bic3) cyclic compounds; and (Bic4) mixtures thereof.

Embodiment 5: The composition of the present invention, wherein the at least one derivative of the at least one α,β ethylenically unsaturated dicarboxylic acid, component (Biib), is selected from the group consisting essentially of: (Biib1) at least one monoester of alcohols having from 1 carbon atom to 29 carbon atoms; (Biib2) at least one anhydride of the at least one derivative of the at least one α,β ethylenically unsaturated dicarboxylic acid; (Biib3) at least one metal salt of the at least one derivative of the at least one α,β ethylenically unsaturated dicarboxylic acid; (Biib4) at least one monoester of the at least one derivative of the at least one α,β ethylenically unsaturated dicarboxylic acid; wherein from 0 percent to 100 percent of the at least one derivative of the at least one α,β ethylenically unsaturated dicarboxylic acid has from 0 percent to 100 percent of carboxylic groups ionized by neutralization with metal ions; and (Biib5) mixtures thereof.

Embodiment 6: The toughened polyamide composition of the present invention, wherein the at least one organic amine, component (C), includes an amine group selected from the group consisting essentially of: (Ci) at least one primary amine group; (Cii) at least one secondary amine group; and (Ciii) mixtures of the at least one primary amine group, component (Ci), and the at least one secondary amine group, component (Cii), in one molecule with the proviso that the functionality of the molecule is below 4.

Embodiment 7: The toughened polyamide composition of the present invention, wherein the toughened polyamide composition containing the at least one organic amine exhibits at least a 10 percent increase in room temperature impact strength or a 10% decrease in the capillary viscosity or both a 10% increase in the room temperature impact and a 10% decrease in the capillary viscosity as compared to a conventional polyamide composition not containing the at least one organic amine.

1. A toughened polyamide composition comprising a blend of:
(A) at least one polyamide;
(B) at least one impact modifier; and
(C) at least one organic amine; wherein the concentration of the at least one organic amine, component (C), is from 0.01 percent by weight to 10 percent by weight.

2. The toughened polyamide composition of claim 1, wherein the at least one organic amine, component (C), includes an amine in one molecule with the proviso that the functionality of the molecule is below 4.

3. The toughened polyamide composition of claim 1, wherein the concentration of the at least one polyamide, component (A), is from 50 percent by weight to 98.99 percent by weight; wherein the concentration of the at least one impact modifier composition, component (B), is from 1 percent by weight to 50 percent by weight; and wherein the concentration of the at least one organic amine, component (C), is from 0.01 percent by weight to 10 percent by weight.

4. The toughened polyamide composition of claim 1, wherein the at least one impact modifier, component (B), is a maleic anhydride-grafted polyolefin elastomer.

5. The toughened polyamide composition of claim 1, wherein the at least one organic amine, component (C), is selected from the group consisting essentially of: R—NH₂, R—NH—R′, NH₂—R—NH₂, R—NH—R′—NH₂, R—NH—R′—NH—R″, and mixtures thereof; wherein R, R′, R″ each separately is an alkyl group, an aryl group, an allyl group, or an alkoxyl group having a carbon number of from 2 to 30.

6. The toughened polyamide composition of claim 1, wherein the at least one organic amine, component (C), is at least one polyether amine.

7. The toughened polyamide composition of claim 1, wherein the at least one organic amine, component (C), is at least one polydimethyl siloxane with at least one primary amine group, or at least one secondary amine group, or a mixture thereof; wherein the at least one primary amine group, the at least one secondary amine group, or a mixture thereof is present at the end of or side chain of the at least one polydimethyl siloxane.

8. A process for preparing a toughened polyamide composition exhibiting high flow and toughness comprising melt-mixing, in one step, a blend of:
(A) at least one polyamide;
(B) at least one impact modifier; and
(C) at least one organic amine; wherein the concentration of the organic amine is from 0.01 percent by weight to 10 percent by weight; and
wherein the melt-mixing step is carried out at a melt-mixing temperature of above 200° C.

9. A process for preparing a toughened polyamide composition exhibiting high flow and toughness comprising the steps of:
(I) soaking at a temperature of below 90° C. for a predetermined period of time, at least the following two components to form a blend composite component:
(α) at least one impact modifier (B); and
(β) at least one organic amine (C); and
(II) melt-mixing, at a temperature of above 200° C. for a predetermined period of time, at least the following two components to form a toughened polyamide composition:
(γ) at least one polyamide; and
(δ) the blend composite component from step (I).

10. (canceled)

11. An article manufactured from the toughened polyamide composition of claim 1.
